(19) United States
(12) Patent Application Publication
(10) Pub. No.: US 2023/0071093 A1
(43) Pub. Date: Mar. 9, 2023

(54) SYSTEM AND METHOD FOR UNIFIED SMART CONTRACT-BASED LISTING AND TRANSACTION OF NFT ASSESTS ACROSS MULTIPLE PLATFORMS

(71) Applicant: VLINDER INC., Monroe, NJ (US)

(72) Inventors: Srinivasan Madhusudhan, Bengaluru (IN); Gururaja Narayana, Bengaluru (IN); Kaliraj Subra Manian, Bengaluru (IN)

(21) Appl. No.: 17/902,801

(22) Filed: Sep. 3, 2022

(30) Foreign Application Priority Data
Sep. 3, 2021 (IN) 202141039934

(51) Int. Cl. G06Q 20/38; G06Q 30/08

(52) U.S. Cl. CPC G06Q 20/3825; G06Q 20/3823; G06Q 30/08

(57) ABSTRACT

A system, method, and platform for listing a Non-Fungible Token (NFT) asset and transparent tracking of transactions are described. According to an embodiment, a system having distributed computing resources receives a digital file, associated metadata, and terms of commercial transactions in natural language through an application interface from a user and creates an NFT from the digital file and associated metadata using an NFT standard. The system receives a selection of one or more marketplaces from the user for listing the NFT, classify the NFT based on the associated metadata for cataloging to the one or more marketplaces, and list the NFT on the one or more marketplaces. The system enables commercial transactions across one or more marketplaces using the unified smart contract.

### FIELD OF THE DISCLOSURE

The present disclosure generally relates to asset listing and transparent transaction tracking across multiple blockchain-based platforms. The present disclosure particularly relates to the system and method for unified smart contract-based listing and transparent transaction tracking of Non-Fungible-Token (NFT) based assets across multiple platforms.

### BACKGROUND OF THE DISCLOSURE

E-commerce transactions related to NFTs assets are gaining a lot of traction across the globe. The term fungible means something that can be replaced by something similar. An NFT is a type of token that can't be replaced by another similar token. It is unique and non-interchangeable. A Non-Fungible token (NFTs) is a digital asset that represents real-world objects, like artwork, music, in-game item, video, sports highlights, collectibles, virtual avatars, designer sneakers, etc. The NFT has become a new class of assets that people want to trade. NFTs allows artists and content creators a unique opportunity to monetize their creativity. Artists no longer have to rely on galleries or auction houses to sell their art. Instead, the artist can sell it directly to the consumer as an NFT, which also lets them keep more of the profits. In addition, the smart contract of the NFT platform allows artists to program in royalties from the future transaction, so they'll receive a percentage of sales whenever their art is sold to a new owner. This is an attractive feature as artists generally do not receive future proceeds after their art is first sold. NFTs are not limited to transacting arts and can enable the transaction of any digital and physical assets having a unique attribute. Brands like Charmin and Taco Bell have auctioned off themed NFT art to raise funds for charity. Nyan Cat, a 2011-era GIF of a cat with a pop-tart body, sold for nearly $600,000 in February 2021. An NBA Top Shot generated more than $500 million in sales as of late March. A single LeBron James highlight NFT fetched more than $200,000. Celebrities are using this opportunity to capture and release unique memories, artwork, and moments as securitized NFTs.

There are many platforms that allow the creation of an NFT from an uploaded asset, listing of NFT assets, and buy/sell transactions. A user intending to list an NFT asset (also referred to as NFT based asset) on multiple marketplaces, however, needs to perform a fixed set of steps for each marketplace. Also, the user needs to understand the catalog or categories under which these assets need to be placed for better visibility.

All these existing platforms are trying their best to incorporate new and emerging technologies in their platforms to make their platform more user-friendly and interactive. Platforms are experiencing various challenges for providing personalized content to the users based on their likes, dislikes, etc., and at the same time, they are facing problems in uploading content like product details, images, cost, etc.

Creators, such as artists, authors, celebrities, etc., mostly have time constraints, and they can spend too much time on each of these platforms to list their assets. Creators may also want to create a personalized marketplace for selling their NFTs. There needs to be an efficient and user-friendly way for maintaining the personalized marketplace, listing the assets, and tracking transactions of the assets. There are several inefficiencies in listing an asset across multiple platforms and tracking transactions of each of these assets across multiple platforms.

On the other hand, the users, who buy and sell the NFTS, may find problems searching for an asset of their interest if assets are not properly classified or tagged. End users are not getting their interfaces as personalized interfaces, due to which their search time increases, making them more frustrated.

Platforms are trying to use new and more advanced versions of the technology to reduce the burden of content uploading and providing personalized choices to the users. There are many NFT platforms that allow users to list the digital assets and perform transactions that are executed with the help of smart contracts. Smart contracts are executable programs that are written in high-level computer programming languages to represent predetermined criteria to trigger the transfer of NFTs. These smart contracts are attached to the nodes of a blockchain to perform various functions. Different smart contracts can hold different NFTs, which again makes it difficult to handle. For this platform, different smart contracts need to be written, which is again a cumbersome process for asset owners.

There are some solutions proposed in the past to address some of the issues highlighted above. For example, an application-specific marketplace is disclosed in the PCT application No. 2020/123464 A1 titled “Decentralized marketplace and ecosystem powered by blockchain-based document delivery, collaboration, and dissemination” ('464 patent). The '464 patent discloses a system, method, and computer program product embodiments for managing documents using a blockchain. A token server system facilitates the creation of a document. The token server system may encrypt and store an encrypted version of the document and create a link to the encrypted version of the document. The token server system may also create a cryptographic hash of the document as well as a document token for depositing in a digital wallet to designate ownership of the document. The token server system may publish the link and the hash to a blockchain using one or more smart contract functions. In some embodiments, the document may be a contract. The token server system may facilitate modifications to the document from other parties. The modifications may represent counteroffers or a negotiation process. The patent disclosed above still does not provides an efficient option for listing assets and tracking the transactions across multiple marketplaces with a single unified smart contract.

A Chinese Patent No. CN113095912, titled “Blockchain-based shopping method” (the '912 patent), discloses application-specific Blockchain. The '912 patent discloses a blockchain-based method for a pre-emptive purchase. An online shopping pre-empting system is established based on a blockchain network, a seller issues digital assets corresponding to a selling object through an intelligent contract in the blockchain network, the digital identity of the digital assets is registered, and the identification of all parties of the selling object written into the digital identity of the digital assets. One or more of the first-aid-buying participants initiates a first-aid-buying request for the digital asset through an intelligent contract in the blockchain network, and the intelligent contract determines that the first-aid-buying participant has initiated the first-aid-buying request for each first-aid-buying participant qualified for the first-aid-buying request. The patent disclosed above still does not provides an efficient option for listing assets and tracking the transactions across multiple marketplaces with a single unified smart contract.

Multiple research scholars are trying to resolve the problems concerning NFTs, which include lack of trust, no control over secondary marketplaces, dependence on intermediaries, no immediate validation, and lack of transparency. One of the research papers titled “NFTs in Practice—Non-Fungible Tokens as Core Component of a Blockchain-based Event Ticketing Application” published under Fortieth International Conference on Information Systems, Munich 2019 discloses the use of NFTs to tokenize digital goods, prevent fraud, and improve control over secondary market transactions. Further, contribute to the generalizable knowledge of the benefits and challenges of NFTs and derive implications for both researchers and practitioners. The above literature discusses the problems concerning NFTs and tries to resolve the problems by recommending some principles. However, the literature does not specifically talk about the issues related to the listing of assets and tracking of asset transactions across multiple marketplaces.

In most existing systems, digital assets are assigned non-fungible tokens and are maintained by Blockchain using hashes attached with the Blockchain's node, which increases the problem of multiple smart contract management and communication of nodes with each other. Listing of tokens or the assets on a platform that is backed by a smart contract is difficult due to its decentralized nature. Users who want to sell their assets by listing the tokens associated with them are required to list their tokens separately using hash values which are a bit complicated.

Therefore, there is a need for a system that provides an efficient and user-friendly way to list and track assets across multiple marketplaces, including personalized marketplace listing and generic market places by using one single, smart contract.

### OBJECTS OF THE INVENTION

An object of the present invention is to provide a system and method for enabling an efficient and user-friendly way to list NFT assets across multiple marketplaces.

An object of the present invention is to provide a platform for listing NFT assets across multiple marketplaces.

An object of the present invention is to provide an auto listing of an asset into a personalized marketplace and general marketplace.

An object of the present invention is to provide a platform for transparent tracking of transactions associated with an NFT.

An object of the present invention is to provide a platform that provides better recommendations for buying/selling NFT assets.

### BRIEF SUMMARY OF THE DISCLOSURE

A system, method, and platform for listing a Non-Fungible Token (NFT) asset and transparent tracking of transactions are described. According to an embodiment, a system having distributed computing resources receives a digital file, associated metadata, and terms of commercial transactions in natural language through an application interface from a user and creates an NFT from the digital file and associated metadata using an NFT standard. The system records ownership of the NFT in a blockchain corresponding to the NFT standard and associates a smart contract with the NFT, wherein the smart contract contains machine-readable instructions related to the terms of commercial transactions. The system converts the terms of the commercial transaction received in natural language from the user into machine-executable instructions. The system receives a selection of one or more marketplaces from the user for listing the NFT, classify the NFT based on the associated metadata for cataloging to the one or more marketplaces, and list the NFT on the one or more marketplaces. The system enables commercial transactions across one or more marketplaces using the unified smart contract.

In an embodiment, one or more marketplaces comprises a personalized marketplace associated with the user and a general marketplace. The system allows the owner of the marketplace to customize the personalized marketplaces for a specific type of assets or assets relating to a particular entity (e.g., a company or an individual). The system automatically lists an asset into the right category and presents the NFT in a time-lined manner on the personalized marketplace.

The NFT standard supported by the system includes but is not limited to ERC-721, ERC-998, ERC-1155, Flow, and Tezos. The system may receive any digital file and create an NFT for that. The digital files include but are not limited to an image, data file, script, artwork, audio, in-game item, video, collectible, virtual avatar, digital twin of a physical asset, a recording of a physical asset. In an embodiment, the digital asset includes every content, goods, documents, securities or anything that is present physically and is converted in its digital version or any asset which itself is present digitally such as Images, Videos, documents, etc. on which non-fungible tokens can be assigned using tokenization for providing uniqueness to the asset.

In an embodiment, the user can list his/her assets on multiple marketplaces through a click of a single button. The users have to select one or more marketplaces, and their assets will automatically be listed in the desired marketplaces. The system maintains and displays the live state of the listed NFTs across multiple marketplaces and enabled transactions across multiple marketplaces with the help of a single smart contract. The smart contract manages how listing-related functions are handled, stored, and created. The smart contract enables the users to list their assets based on their requirements.

As one will appreciate, NFTs are uniquely identifying digital assets which are used for their unique property of delivering uniqueness and authenticity to the digital asset by tokenization. Uniqueness is provided by NFTs as only one user is authorized to possess NFT for one digital asset at a time. These NFTs can further be sold, bought, and kept by the user. The proposed system helps track the ownership and facilitates the transaction of NFTs using virtual currency or fiat currency.

The system enables the transfer of NFTs, which leads to the transfer of whole ownership rights concerning digital and physical assets that include the right to sell, hold, modify, etc. The system also can facilitate the transfer of selected rights and impose restrictions on future transactions with the help of the smart contract. The system may provide features to the creator to get a royalty from each future transaction related to an NFT asset that he/she created. As the ownership changes, the system helps to maintain the transaction details in Blockchain.

The Features and advantages of the subject matter hereof will become more apparent in light of the following detailed description of selected embodiments, as illustrated in the accompanying FIGUREs. As will be realized, the subject matter disclosed is capable of modifications in various respects, all without departing from the scope of the subject matter. Accordingly, the drawings and the description are to be regarded as illustrative.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description applies to any one of the similar components having the same first reference label irrespective of the second reference label.

FIG. 1 is a block diagram illustrating a network view of an NFT based asset management system in accordance with an embodiment of the present disclosure.

FIG. 2 illustrates the functional modules of an NFT-based asset management system in accordance with an embodiment of the present disclosure.

FIG. 3A shows a generalized embodiment of an exemplary computing device used by a user or creator to access the system in accordance with an embodiment of the present disclosure.

FIG. 3B a block diagram illustrating the component of a mobile device used by a user or creator to access the system in accordance with an embodiment of the present disclosure.

FIG. 4 is an example block diagram illustrating the submission of an asset and listing of the asset on multiple marketplaces in accordance with an embodiment of the present disclosure.

FIG. 5 illustrates the examples of the interface of a user to enable listing NFT assets and transacting the NFT assets in accordance with an embodiment of the present disclosure.

FIG. 6 illustrates an example interface of a personalized marketplace having assets listed under different categories.

FIG. 7 illustrates an example user interface recommending assets to a user in accordance with an embodiment of the present disclosure.

FIG. 8 a flow diagram illustrating a process of listing an NFT and tracking NFT transactions using Blockchain in accordance with an embodiment of the present disclosure.

### DETAILED DESCRIPTION

In the following description, for purposes of explanation, numerous specific details are outlined in order to provide a thorough understanding of the present disclosure. It will be apparent, however, to one skilled in the art that the present disclosure is not limited to these specific details.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments.

Further, the terms “a” and “an” herein do not denote a limitation of quantity but rather denote the presence of at least one of the referenced items. As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

Moreover, various features are described, which may be exhibited by some embodiments and not by others. Similarly, various requirements are described, which may be requirements for some embodiments but not for other embodiments.

Furthermore, in the following detailed description of the present disclosure, numerous specific details are outlined to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Embodiments of the present disclosure include various steps, which will be described below. The steps may be performed by hardware components or may be embodied in machine-executable instructions, which may be used to cause a general-purpose or special purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded following various methods described herein and the method steps of the disclosure could be accomplished by modules, routines, subroutines, or subparts of a computer program product.

Embodiments described herein may be discussed in the general context of computer-executable instructions residing on some form of computer-readable storage media, such as program modules, executed by one or more computers or other devices. By way of example, and not limitation, computer-readable storage media may include non-transitory computer-readable storage media and communication media; non-transitory computer readable media include all computer-readable media except for a transitory, propagating signal. Generally, program modules include routines, programs, objects, components, data structures, etc., that perform particular tasks or implement abstract data types. The functionality of the program modules may be combined or distributed as desired in various embodiments.

Some portions of the detailed description that follows are presented and discussed in terms of a process or method. Although steps and sequencing thereof are disclosed in figures herein describing the operations of this method, such steps and sequencing are exemplary. Embodiments are well suited to performing various other steps or variations of the steps recited in the flowchart of the figure herein and in a sequence other than that depicted and described herein. Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result.

In some implementations, the flowchart and block diagrams in the Figures illustrate the architecture, functionality, and operation of possible implementations of apparatus (systems), methods, and computer program products according to various implementations of the present disclosure. Each block in the flowchart and/or block diagrams, and combinations of blocks in the flowchart and/or block diagrams, may represent a module, segment, or portion of code, which includes one or more executable computer program instructions for implementing the specified logical function(s)/act(s). These computer program instructions may be provided to a processor of a general-purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of order noted in the figures. For example, two blocks shown in succession may be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer-implemented process such that the instructions which execute on the computer or other programmable apparatus provide steps for implementing the functions/acts (not necessarily in a particular order) specified in the flowchart and/or block diagram block or blocks or combinations thereof.

### Terminology

Brief definitions of terms used throughout this application are given below.

The terms connected, coupled, and related terms are used in an operational sense and are not necessarily limited to a direct connection or coupling. Thus, for example, two devices may be coupled directly or via one or more intermediary media or devices. As another example, devices may be coupled in such a way that information can be passed therebetween while not sharing any physical connection. Based on the disclosure provided herein, one of ordinary skill in the art will appreciate a variety of ways in which connection or coupling exists in accordance with the aforementioned definition.

As used herein, a token assignment refers to assigning an NFT to a digital file (e.g., JPEG, PDF, DOC. Etc.) by associating user/subject rights and restrictions with established identities.

While embodiments of the present disclosure have been illustrated and described, it will be clear that the disclosure is not limited to these embodiments only. Numerous modifications, changes, variations, substitutions, and equivalents, will be apparent to those skilled in the art without departing from the spirit and scope of the disclosure, as described in the claims.

Thus, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular name.

In an embodiment, a system implemented over a distributed computing resources that have one or more computer systems subscribed to work in accordance with a mutually agreed mechanism to cryptographically encrypting data and transactions, storing the data and transaction records in Blockchain across multiple nodes, and validate those data and transactions when requested.

It's important to note that the term “blockchain” as used here refers to any electronic, computer-based, distributed ledger. It should be noted that the disclosure is not limited to use with NFTs and alternative blockchain implementations and protocols fall within the scope of the present disclosure.

Blockchain is a distributed ledger technology that allows many users to conduct transactions while maintaining an immutable record of those events. A network of nodes must first agree that a matching transaction is legitimate before moving anything of value via any type of Blockchain. Blockchain ledgers may be administered autonomously to transmit information between remote participants as a peer-to-peer network paired with a distributed time-stamping server. In effect, the blockchain users are the administrator.

Blockchain's rapid development has given rise to many different kinds of chains, tokens, and smart contracts. Within a single blockchain, a miner has visibility to all transactions on the single Blockchain. However, the miner does not have visibility, for example, to pending transactions on another blockchain.

It is important to note here that NFT here refers to non-fungible tokens which is a digital asset that symbolizes physical objects such as art, music, in-game goods, and movies. NFT can be purchased and sold online in exchange for bitcoin or any other fiat currency. NFT also allows the buyer to retain ownership of the original item.

Each NFT contains a digital signature that prevents NFTs from being traded to one another. An NFT is minted from digital assets that represent both tangible and intangible commodities, such as art, GIFs, films, sports highlights, Collectibles, virtual avatars, video game skins, designer shoes, or music. At any given moment, NFTs can only have one owner because NFTs include unique data. It is simple to verify ownership and transfer tokens between owners. Artists and content providers may use NFTs to monetize their work. For example, an artist can no longer have to sell their work through galleries or auction houses. Instead, the artist may sell it as an NFT straight to the consumer, allowing him to keep a larger portion of the profit. For performing all these transactions, the user requires a proper marketplace platform where a listing of tokens takes place using a smart contract.

It is important to note that a smart contract here refers to the piece of software present in the utility of the Blockchain for keeping a record of a transaction in a blockchain. Smart contracts are executed by a computer network that uses consensus protocols to agree upon the sequence of actions resulting from the contract's code. With a snared database running a blockchain protocol, smart contracts auto-execute, and all parties validate the outcome instantaneously and without the need for a third-party intermediary.

The smart contract helps in the listing of NFTs. The NFT may be associated with an expiration term and, in an event exchange of the NFT is not completed before the expiration term expires, an embodiment may unwind the NFT.

It is important to note that digital assets may include every intangible item, which may include digital documents, securities, videos, images, etc. It also includes physical assets that are movable as well as immovable property and can be converted to a digital asset by capturing, uploading, or entering on a platform. Each digital asset not only holds a uniquely identifying NFT but also holds associated rights with it, and any transfer of NFT leads to the transfer of these rights also.

It is important to note that in the present disclosure, Ownership rights are referred to all the digital as well as physical rights associated with the asset, which includes:

1. Right to hold.
2. Right to sale.
3. Right of ownership.
4. Right to modify.

### 5. Right to use.

6. Right to possess.
7. Right to adapt.
8. Right of paternity.
9. Right of ownership.

All these rights mentioned above are transferred along with the transfer of NFTs from one user to another.

The marketplace is a platform that provides buying and selling of NFTs, digital assets, and associated physical assets.

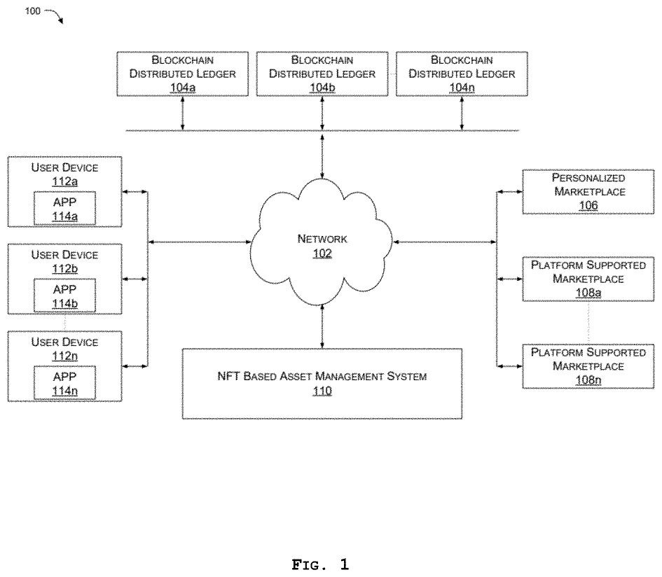

FIG. 1 is a block diagram illustrating a network view of an NFT based asset management system in accordance with an embodiment of the present disclosure. The NFT based asset management system 110 allows a user connected through network 102 from a user device (e.g., user device 112a, user device 112b, or user device 112n, etc.) running custom application (e.g., App 114a, app 114b, App 114n, etc.) to create an NFT by uploading a digital file, track all the NFTs owned by them and buy or sell NFTs. In an embodiment, the system supports blockchain-based personalized marketplaces with multiple front ends. The system works as a platform to connect creators, buyers, sellers, advertisers using the blockchain ecosystem. The user device may include every electronic device which is connected to the Internet, such as laptop, mobile device, tablet PC, etc. Multiple users are allowed to perform functions on a platform, and users can join the platform from multiple devices also. User Device may include one or more user interfaces, such as browsers and textual or graphical user interfaces, through which users may access system 110. These user devices 114a-n are further connected with Blockchain via network 102. A Blockchain network is a technical infrastructure that provides ledger and smart contract services to applications. Smart contracts are used to generate transactions which are subsequently distributed to every peer node in the network, where they are immutably recorded on their copy of the ledger. System 110 may use distributed storage, which is responsible for keeping a record of already assigned NFTs, and transaction of NFTs.

The user device may have a digital wallet associated with holding crypto assets. The digital wallet of the user shall also be connected with the wallet of choice. The custom application can be integrated with the digital wallet or can interact with the digital wallet using suitable APIs. A user, who may be a content creator, can create digital work or upload digital work for creating an NFT. The System 110 on receiving a digital file can generate an NFT using an NFT standard and anchor the NFT into Blockchain distributed ledger (e.g., Blockchain distributed ledger 104a, Blockchain distributed ledger 104b, and Blockchain distributed ledger 104n). In an embodiment, the system supports minting of NFTs and places the request for NFT at suitable based on operational price to minimize the cost. The system can predict based on historical learning a suitable time for minting the NFT.

System 110 allows users to list the NFT asset on one or more marketplaces, including personalized marketplace 106 or platform supported marketplaces (e.g., marketplace 108b, and marketplace 108n). System 110 allows users to select one or more marketplaces using an interactive webpage interface or mobile application interface. System 110 also recommends a suitable marketplace for an asset type for listing. System 110 can perform autocataloging of the asset based on the catalog structure of the target marketplaces. An asset can be placed in one category on the first marketplace and in another category on a second marketplace. System 110 allows users to upload one or more digital files to create NFT for each one or more digital files. System 110 also allows users to create multiple NFTs for a single digital file and transact each of the NFTs separately.

The system allows users to list or buy NFTs in the marketplaces by using cryptocurrency or fiat currency. The marketplace consists of smart contracts embedded in a blockchain that helps the NFTs for listing and transfer of NFTs from one user to another. The marketplace includes a personal marketplace or a public marketplace.

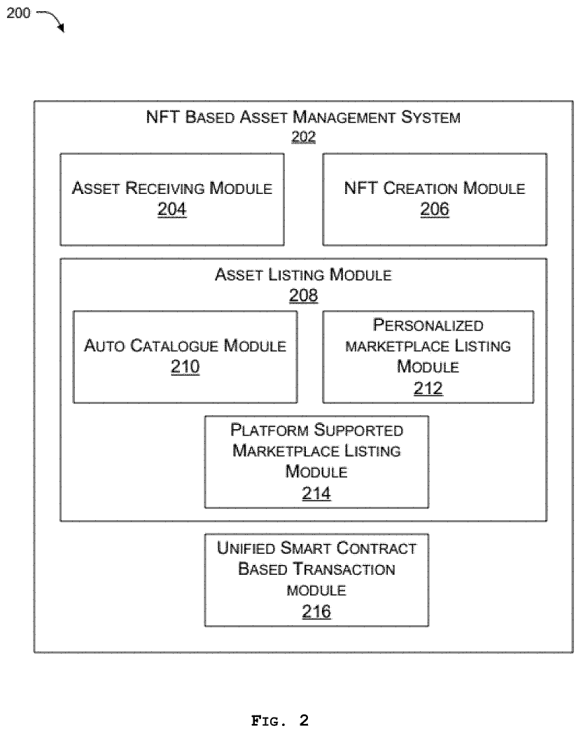

FIG. 2 illustrates the functional modules of an NFT-based asset management system in accordance with an embodiment of the present disclosure. The NFT based asset management system 202 (same as system 110) enables the listing of a Non-Fungible Token (NFT) asset and facilitates transparent transaction tracking of NFT assets. The system includes an asset receiving module 204 configured to receive, at distributed computing resources, a digital file, associated metadata, and terms of commercial transactions in natural language, through an application interface from a user. The associated metadata includes a description of the file, importance of the asset, uniqueness of the asset explained from the creator's point of view, location information, event information, data, etc. The asset receiving module 204 may also receive input on the number of NFTs that need to be created for the submitted digital file. The asset receiving module 204 allows users to submit NFT creation requests from a dedicated application or a web-based interface.

System 202 includes an NFT creation module 206 configured, at the distributed computing resources, to create an NFT from the digital file and associated metadata using an NFT standard. Module 206 records ownership of the NFT in a blockchain corresponding to the NFT standard and associates a smart contract with the NFT. The smart contract contains machine-readable instructions related to the terms of commercial transactions. In an embodiment, system 202 may use an NLP to machine instruction translation engine to convert the natural language terms of transactions received from the user into machine-readable instructions to be included as part of the smart contract.

System 202 includes an asset listing module 208 configured, at the distributed computing resources, to receive a selection of one or more marketplaces from the user for listing the NFT, classify the NFT based on the associated metadata for cataloging to the one or more market places, and list the NFT on the one or more marketplaces. The asset listing module 208 includes an auto catalog module 210 to classify the NFT asset based on metadata associated with the digital file and catalog structure of a target marketplace. The auto catalog module 210 may use classification algorithms, such as decision tree, K-nearest neighbors, support vendor machine, Naïve Bayes, etc.

The asset listing module 208 includes a personalized marketplace listing module 212 configured to list the NFT into a personalized marketplace. The personalized marketplace may have its own structural requirement and fields that need to be updated. The personalized marketplace listing module 212 may pull the requirement of the target marketplace and fill the details in the required format for a listing of the NFT. The personalized marketplace listing module 212 can place the NFT in a time-lined manner based on the date of creation basis or on the date of event basis. The personalized marketplace listing module 212 allows users to personalize the marketplaces for a specific theme, genre, personality, sports, movie, place, etc.

The asset listing module 208 includes a platform-supported marketplace listing module 214 configured to facilitate the listing of NFT assets on compatible marketplaces. The platform-supported marketplaces or compatible marketplaces are those that use the same NFT standards and smart contracts for transacting the NFTs. For example, if the system generates NFT using ERC-721, which is an NFT standard supported by etherium Blockchain, the platform-supported marketplaces are all the marketplace that allows Etherium blockchain based transactions.

System 202 further includes a unified smart contract-based transaction module 216 configured to enable commercial transactions across one or more marketplaces using the smart contract. As one will appreciate, a single smart contract is used to confirm ownership of the NFT asset and facilitate transactions. The unified Smart contract-based transaction module 216 tracks all the transactions in a transparent manner. Module 216 allows the system to maintain and display consistent state information of the NFT across all the marketplaces. If the asset is sold at one marketplace, the state of the NFT across all the marketplaces will automatically reflect that.

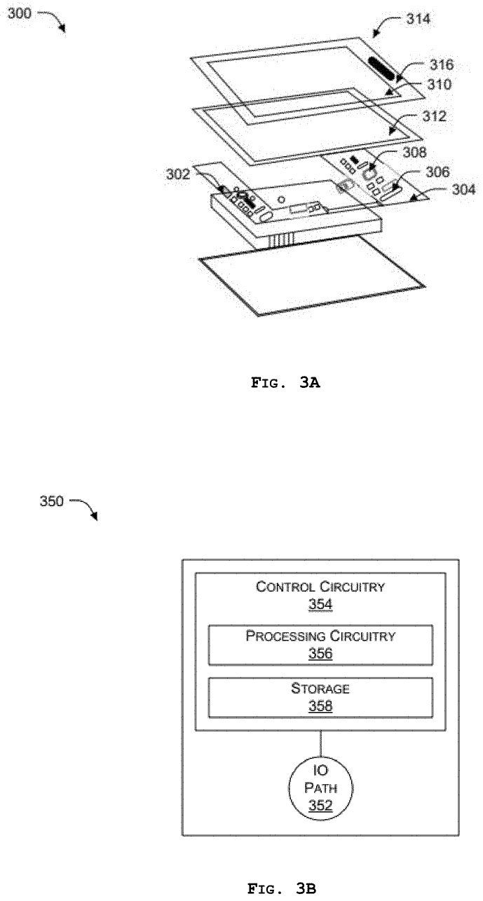

FIG. 3A shows a generalized embodiment of an exemplary computing device used by a user or creator to access the system in accordance with an embodiment of the present disclosure. As depicted, the computing device 300 may be a smartphone or a tablet. The computing device 300 may receive content and data via an input/output (hereinafter “I/O”) path 302. The I/O path 302 may provide metadata, voice profiles, and/or voice clips to control circuitry 304, which includes processing circuitry 306 and storage 308. The control circuitry 304 may send and receive commands, requests, and other suitable data using the I/O path 302. The I/O path 302 may connect the control circuitry 304 (and specifically the processing circuitry 306) to one or more communications paths (described below). I/O functions may be provided by one or more of these communications paths but are shown as a single path in FIG. 3A to avoid overcomplicating the drawing.

The control circuitry 304 may be based on any suitable processing circuitry, such as the processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quadcore, Hexa-core, or any suitable number of cores) or supercomputer. In some embodiments, the processing circuitry is distributed across multiple separate processors or processing units of different types, for example, multiple of the same type of processing units (e.g., two Intel Core i7 processors) or multiple different processors (e.g., an Intel Core i5 processor and an Intel Core i7 processor).

In some embodiments, the control circuitry 304 executes instructions for facilitating real estate transactions stored in memory (i.e., storage 308). Specifically, the control circuitry 304 may be instructed to perform searching, retrieve data and/or voice profiles or voice clips, and/or perform the other functions discussed above and below.

In client/server-based embodiments, the control circuitry 304 includes communications circuitry suitable for communicating with a real estate transaction facilitation platform or other networks or servers. The instructions for carrying out the above-mentioned functionality may be stored on a server or a cloud database. Communications circuitry may include a cable modem, integrated services digital network (ISDN) modem, a digital subscriber line (DSL) modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of client devices or communication of media devices in locations remote from each other.

The memory may be an electronic storage device provided as the storage 308 that is part of the control circuitry 304. As referred to herein, the phrase “electronic storage device” or “storage device” should be understood to mean any device for storing electronic data, computer software, or firmware, such as random-access memory, hard drives, optical drives, solid-state devices, quantum storage devices, or any other suitable fixed or removable storage devices, and/or any combination of the same. Nonvolatile memory may also be used (e.g., to launch a boot-up routine and other instructions). Cloud-based storage may be used to supplement the storage 308 or instead of the storage 308.

The control circuitry 304 may include audio processing circuitry and/or audio generation circuitry, other digital encoding or decoding circuitry, or any other suitable audio circuits or combinations of such circuits. Encoding circuitry (e.g., for converting received audio input or digital signals to audio signals for analysis or storage) may also be provided. The audio circuitry may be used by the computing device 300 to receive, process, and generate audio input or output. The circuitry described herein, including, for example, audio generating, encoding, decoding, encrypting, decrypting, and analog/digital circuitry, may be implemented using software running on one or more general-purpose or specialized processors. Multiple circuits may be provided to handle simultaneous processing functions. If storage 308 is provided as a separate device from the media device 300, the circuitry may be associated with storage 308.

A user may send instructions to the control circuitry 304 using a user input interface 310 of the computing device 300. The user input interface 310 may be any suitable user interface, such as a remote control, mouse, trackball, keypad, keyboard, touch screen, touchpad, stylus input, joystick, or other user input interfaces. Display 312 may be a touchscreen or touch-sensitive display. In such circumstances, user input interface 310 may be integrated with or combined with the display 312. A camera, microphone 316, or other visual or voice recognition interface may also be used to receive user input (e.g., voice prompts). Speakers 314 may be provided as integrated with other elements of the computing device 300.

The interactive application and/or any instructions for performing any of the embodiments discussed herein may be encoded on computer-readable media. Computer-readable media includes any media capable of storing data. In some embodiments, the real estate transaction facilitation application is a client/server-based application. Data for use by a thick or thin client implemented on the computing device 300 is retrieved on-demand by issuing requests to a server remote to the computing device 300, as described above. For example, the computing device 300 may receive inputs from the user via the input interface 310 or the microphone 316 and transmit those inputs to the remote server (e.g., cloud database 208) for processing and generating the corresponding outputs. The generated output is then transmitted to the computing device 300 to be output to the user. Those skilled in the art will appreciate that respective client devices used by different stack holder 202a-i may be implemented as media device 300 of FIG. 3A.

FIG. 3B a block diagram illustrating the component of a mobile device used by a user or creator to access the system in accordance with an embodiment of the present disclosure. The mobile device 350 may receive data related to NFT listing and transactions via an input/output path 352. The I/O path 352 may provide data related to NFT based transactions and other required services to control circuitry 354. Control 354 includes a processing circuitry 356 configured to process the data and execute instructions to perform functions of the system 400 described above. The control circuitry 354 includes a storage 358 that stored programmable instructions and other data relating to NFT transactions. The control circuitry 354 may send and receive commands, requests, and other suitable data using the I/O path 352. The I/O path 352 may connect the control circuitry 354 to one or more communications paths.

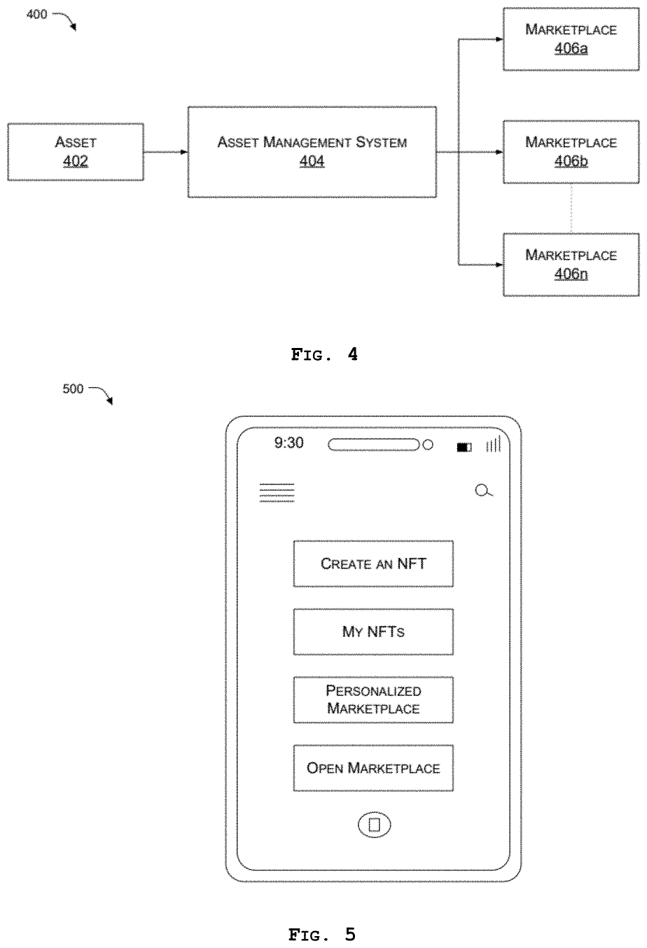

FIG. 4 is an example block diagram illustrating the submission of an asset and listing of the asset on multiple marketplaces in accordance with an embodiment of the present disclosure. Although embodiments of the present invention are described in the context of listing NFT based assets on multiple platforms, the solution can be extended to support the listing of any type of asset or media content on multiple marketplaces with a single click. As shown in FIG. 4, an asset management system 404 can receive an asset 402 and associated metadata and converts the received details in the formats specific to the marketplaces, such as marketplace 406a, marketplace 406b, and marketplace 402n. For listing asset 402 to different platforms, the system 404 pulls the requirements, such as mandatory fields and other data collection options, from the target marketplace and auto-populates the data. System 404 may get the required data from the user or perform auto-scraping of data based on the user-submitted data. For example, if a user lists an image for sale, the system 404 can identify the description of the image by searching the Internet. The image may be of a player boosting winning of a match. The match details and some summarized content can be pulled from the open Internet and filled in the required format of the target platform.

FIG. 5 illustrates an example interface that enables a user to list NFT assets and transact the NFT assets in accordance with an embodiment of the present disclosure. The interface 500 may present multiple options, including but not limited to an option to create an NFT, view existing NFT assets, visit a personalized marketplace, visit open marketplaces. A user can create an NFT by uploading a digital file, adding descriptions and other supplementary details related to the digital file. Once uploaded, the interface may allow the users to specify the number of NFTs that the user wishes to create and also select one or more marketplaces where a user wishes to list the NFTs.

The interface may also present options to the user to select the NFT standard that the user wishes to use for NFT creation. Based on the NFT standard selected by the user, the system may automatically update the compatible marketplaces.

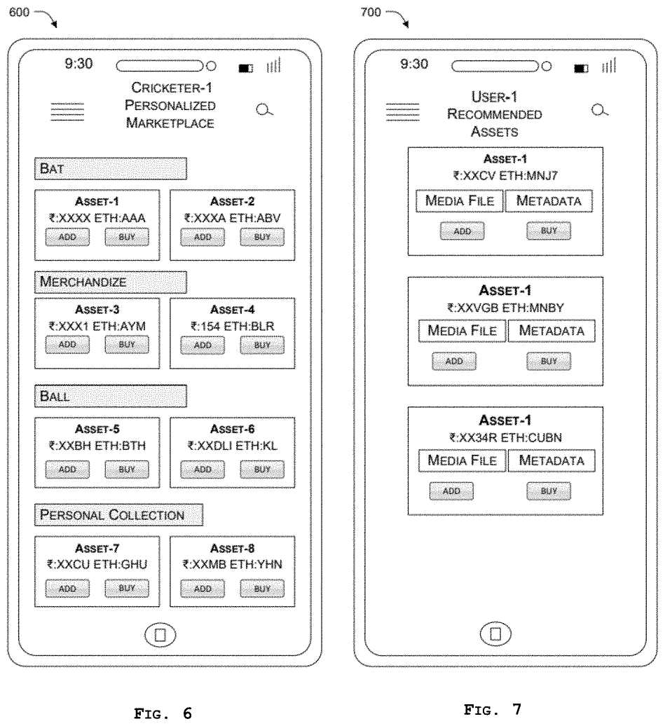

FIG. 6 illustrates an example interface of a personalized marketplace having assets listed under different categories. The interface 600 is an example interface of a personalized marketplace of a cricket player. The system allows users to create a personalized market by filling in basic survey questions. For example, the system may collect information on a specific theme (sports, sports-cricket, movie, movie-GOT, artwork, etc.) and entity details (individual, place, production house, sports club, producer name, etc.) and create a personalized marketplace. Depending on the theme and the entity details selected by the user, the system may automatically create a catalog for the user. The user may add, delete or edit any category. Once the personalized marketplace is created, the system can auto-assign a matching category to the asset based on the category description and asset description. As shown in interface 600, for a marketplace for cricketer-1, the categories may be a bat, merchandise, ball, personal collection, etc. The system can list the asset under the matching category. Other users (other than the user who owns the marketplaces) can buy or sell NFT assets on the personalized marketplace. The personalized marketplace can be accessed through a dedicated mobile application or through a web interface.

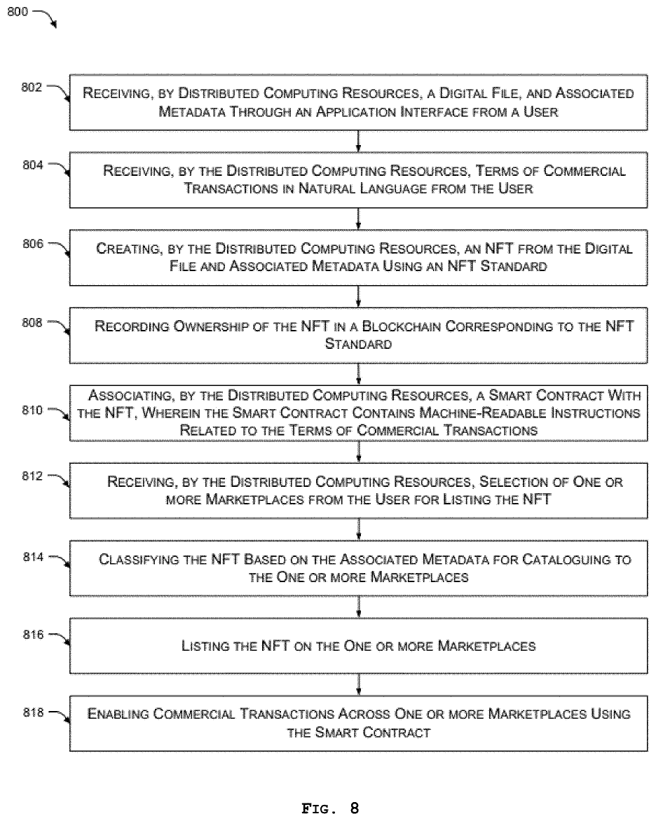

FIG. 7 illustrates an example of user interface 700 recommending assets to a user in accordance with an embodiment of the present disclosure. Interface 700 lists recommended NFT assets for a user-1 based on the user's previous transaction and also based on the predicted value of an NFT. The recommendation engine of the system considers the affinity of the user (e.g., user 1) with the creator of the NFT, type of digital file converted into NFT, additional metadata, genre, etc. Interface 700 may also present a media file describing the uniqueness of the NFT assets, a summary of transactions, and commentary from the creator. Interface 700 may also present metadata for each asset. The metadata may be the same as posted by the creator or can be collected from the web.

FIG. 8 a flow diagram illustrating a process of listing an NFT and tracking NFT transactions using Blockchain in accordance with an embodiment of the present disclosure. Process 800 includes steps of receiving, by distributed computing resources, a digital file, and associated metadata through an application interface from a user, as shown at block 802, receiving, by the distributed computing resources, terms of commercial transactions in natural language from the user, as shown at block 804, creating, by the distributed computing resources, and NFT from the digital file and associated metadata using an NFT standard, as shown at block 806, and recording ownership of the NFT in a blockchain corresponding to the NFT standard, as shown at block 808. Process 800 further includes steps of associating, by the distributed computing resources, a smart contract with the NFT, as shown in block 810. The smart contract contains machine-readable instructions related to the terms of commercial transactions.

The process 800 further includes steps of receiving, by the distributed computing resources, selection of one or more marketplaces from the user for listing the NFT, as shown at block 812, classifying the NFT based on the associated metadata for cataloging to the one or more marketplaces, as shown at block 814, listing the NFT on the one or more marketplaces, as shown at block 816 and enabling commercial transactions across one or more marketplaces using the smart contract, as shown at block 818.

In an embodiment, a seller who is having possession of NFT, as well as a digital asset (also referred to as an owner of the asset), can quote his expected prices, offered, etc. The Seller holds the assigned NFT and also every right associated with NFT, digital and physical assets. A buyer who has a keen interest in the asset and associated NTT and is willing to buy the asset and associated rights with the asset can quote a price that he is willing to pay. The system facilitates bidding of the NFT asset and sells the NFT to one with the highest price, provided other terms of the contract are fulfilled. Seller may have full ownership of the assets which include, physical asset, digital twin of the physical asset, digital rights, and NFT associated with it. The system may allow the transfer of selected rights and assign different owners with different rights. Once a buyer has located an NFT of interest to him, certain functions will allow the buyer to request the token from the current holder, i.e., Seller, or to put a marketplace offer in for the NFT. This request can only be considered if the Seller has listed his NFT for sale. The whole transfer of NFT from the Seller to a buyer is incorporated in Blockchain and is handled based on the smart contract. The Blockchain is responsible for holding data which includes Seller and Buyer's details, NFT assigned with digital asset, and verification of tokens. The transfer of NFTs not only allows the transfer of NFT and digital assets but also includes the transfer of all the rights associated with it. Assignment of NFT also means the assignment of various rights. These rights include:

1. Right to hold.
2. Right to sale.
3. Right of ownership.
4. Right to modify.

### 5. Right to use.

6. Right to possess.
7. Right to adapt.
8. Right of paternity.
9. Right of ownership.

All these rights are embedded in NFT, and the person who will be holding the assigned NFT

shall also be holding all these rights. In an embodiment, transfer of NFT leads to the transfer of these rights also, and the user by whom the rights have been transferred shall hold no right on the transferred NFT.

### Advantages of the Invention

The proposed invention provides a system and method for enabling efficient and user-friendly ways to list an NFT asset across multiple marketplaces.

The proposed invention provides a platform for listing NFT assets across multiple marketplaces.

The proposed invention provides an auto listing of an asset into a personalized marketplace and general marketplace.

The proposed invention provides a platform for transparent tracking of transactions associated with an NFT.

The proposed invention provides a platform that provides better recommendations for buying/selling NFT assets.

We claim:

1. A method for listing a Non-Fungible Token (NFT) asset and transaction tracking, the method comprising:
receiving, by distributed computing resources, a digital file, and associated metadata through an application interface from a user;
receiving, by the distributed computing resources, terms of commercial transactions in natural language from the user;
creating, by the distributed computing resources, and NFT from the digital file and associated metadata using an NFT standard;
recording ownership of the NFT in a blockchain corresponding to the NFT standard;
associating, by the distributed computing resources, a smart contract with the NFT, wherein the smart contract contains machine-readable instructions related to the terms of commercial transactions;
receiving, by the distributed computing resources, selection of one or more marketplaces from the user for listing the NFT; classifying the NFT based on the associated metadata for cataloging to the one or more market places;
listing the NFT on one or more marketplaces; and
enabling commercial transactions across one or more marketplaces using the smart contract.

2. The method of claim 1, wherein the one or more marketplaces comprises personalized marketplace associated with the user and a general marketplace.

3. The method of claim 2 further comprising presenting the NFT in a time-lined manner on the personalized marketplace.

4. The method of claim 1, wherein the NFT standard comprises ERC-721, ERC-998, ERC-1155, Flow, and Tezos.

5. The method of claim 1, wherein the digital file is any or combination of an image, data file, script, artwork, audio, in-game item, video, collectible, virtual avatar, digital twin of a physical asset, a recording of a physical asset.

6. A system for listing a Non-Fungible Token (NFT) asset and transaction tracking, the system comprising:
an asset receiving module configured to receive, at distributed computing resources, a digital file, associated metadata, and terms of commercial transactions in natural language, through an application interface from a user;
an NFT creation module configured at the distributed computing resources to
create an NFT from the digital file and associated metadata using an NFT standard,
record ownership of the NFT in a blockchain corresponding to the NFT standard; and
associate a smart contract with the NFT, wherein the smart contract contains machine-readable instructions related to the terms of commercial transactions;
an asset listing module configured at the distributed computing resources to
receive a selection of one or more marketplaces from the user for listing the NFT;
classify the NFT based on the associated metadata for cataloguing to the one or more market places; and
list the NFT on one or more marketplaces; and
a unified smart contract-based transaction module configured to enable commercial transactions across one or more marketplaces using the smart contract.

7. The system of claim 6, wherein the one or more marketplaces comprises a personalized marketplace associated with the user and a general marketplace.

8. The system of claim 7 further comprising a personalized marketplace listing module configured to present the NFT in a time-lined manner on the personalized marketplace.

9. The system of claim 6, wherein the NFT standard comprises ERC-721, ERC-998, ERC-1155, Flow, and Tezos.

10. The system of claim 6, wherein the digital file is any or combination of an image, data file, script, artwork, audio, in-game item, video, collectible, virtual avatar, digital twin of a physical asset, a recording of a physical asset.
